(19) United States
(12) Patent Application Publication
(10) Pub. No.: US 2010/0117448 A1
(43) Pub. Date: May 13, 2010

(54) BRAKING SYSTEM FOR MOTOR VEHICLES

(76) Inventors: Hans-Jorg Feigel, Rosbach (DE); Heiko Gastauer, Losheim am see (DE); Axel Hinz, Neu-Anspach (DE); Lothar Schiel, Hofheim (DE)

Correspondence Address: RATNERPRESTIA, P.O. BOX 980, VALLEY FORGE, PA, 19482, US

(21) Appl. No.: 12/594,483

(22) PCT Filed: Mar. 11, 2008
(86) PCT No.: PCT/EP08/52888

§ 371 Date: Oct. 2, 2009

(30) Foreign Application Priority Data
Apr. 5, 2007 (DE) 10 2007 016 954.1
May 26, 2007 (DE) 10 2007 024 785.2

(51) Int. Cl. B60T 8/40; B60T 8/60

(52) U.S. Cl. 303/155

(57) ABSTRACT

In order to embody an electrohydraulic brake system of the brake-by-wire type in a way which is optimized in terms of installation space, it is proposed that a booster device for boosting the activation force which is transmitted to a pressure sensor by the brake pedal is composed of a booster module, which is connected upstream of the pressure sensor, and of a hydraulic pressure source, and in that the pressure sensor forms, with the booster module, a first functionally capable assembly which can be handled independently, and a pressure source, an electronic open-loop and closed-loop control unit and a valve block which accommodates the pressure control valves form a second functionally capable assembly which can be handled independently and which is arranged spatially separate from the first assembly.

### CROSS REFERENCE TO RELATED APPLICATIONS

This application is the U.S. national phase application of PCT International Application No. PCT/EP2008/052888, filed Mar. 11, 2008, which claims priority to German Patent Application No. 102007016954.1, filed Apr. 5, 2007 and German Patent Application No. 102007024785.2, filed May 26, 2007, the contents of such applications being incorporated by reference herein.

### BACKGROUND OF THE INVENTION

1. Field of the Invention

The invention relates to an electrohydraulic brake system for motor vehicles of the brake-by-wire type, having:

a hydraulic brake pressure sensor which can be activated by means of a brake pedal, and a master brake cylinder having at least one pressure space which is bounded by a master cylinder piston and to which wheel brakes of the motor vehicle can be connected,

means for decoupling the brake pedal from the pressure sensor, a booster device which is effectively connected upstream of the brake pressure sensor and has the purpose of generating an activation force which acts on the pressure sensor,

means for sensing a vehicle deceleration request, the control signals of which can be fed to an electronic open-loop and closed-loop control unit, a pedal force simulator which interacts with the brake pressure sensor and by means of which a restoring force which acts on the brake pedal can be simulated in the brake-by-wire operating mode, and having pressure control valves which can be actuated by the electronic open-loop and closed-loop control unit and are assigned to the wheel brakes.

2. Description of the Related Art

Such a brake system is known from DE 10 2005 018 649 A1. An electric motor with a transmission stage which is connected downstream and which interacts directly with the master brake cylinder piston serves to perform the boosting of the activation force which is applied to the brake pedal by the driver. The decoupling of the brake pedal from the master brake cylinder is carried out mechanically by means of an axial distance between the brake pedal, or an activation rod coupled to the brake pedal, and the master cylinder piston. However, this type of decoupling results in a loss of pedal travel in the event of emergency braking. In the previously known brake system, the structurally required necessity to mount the previously known electric motor in the direct vicinity of the master brake cylinder, i.e. on the splash wall of the vehicle, which causes unfavorable noises and vibrations, is felt to be less advantageous. Furthermore, the electric motor constitutes a considerable mass which has an adverse effect, in particular in the event of a crash.

### SUMMARY OF THE INVENTION

An object of the present invention is therefore to eliminate the abovementioned disadvantages of a brake system of the generic type mentioned at the beginning.

This object is achieved according to aspects of the invention, in that the booster device for boosting the activation force which is transmitted to the pressure sensor by the brake pedal is composed of a booster module, which is connected upstream of the pressure sensor, and of a hydraulic pressure source, and in that the pressure sensor forms, with the booster module, a first functionally capable assembly which can be handled independently, and the pressure source, the electronic open-loop and closed-loop control unit and a valve block which accommodates the pressure control valves form a second functionally capable assembly which can be handled independently and which is arranged spatially separate from the first assembly.

These measures minimize the installation space to a considerable degree, with the described disintegrated design permitting adaptation to various vehicle models merely through corresponding configuration of the second assembly.

### BRIEF DESCRIPTION OF THE DRAWINGS

Further features and advantages of the invention are explained in more detail in the following description of an exemplary embodiment with reference to the appended drawing.

In the drawing,

FIG. 1 shows a basic circuit diagram of the brake system according to aspects of the invention, and

FIG. 2 shows the first assembly on an enlarged scale.

### DETAILED DESCRIPTION OF THE PREFERRED EMBODIMENTS

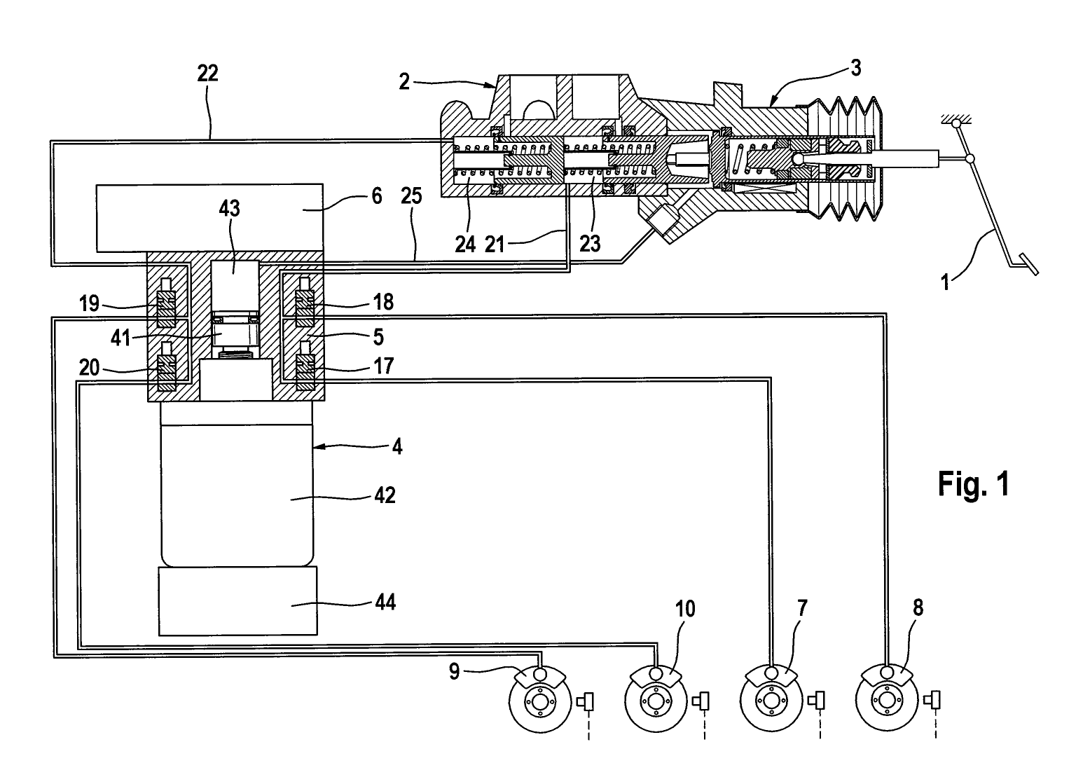

The electrohydraulic brake system according to aspects of the invention illustrated in the drawing is composed essentially of a hydraulic brake pressure sensor 2 which can be activated by means of a brake pedal 1, a booster module 3 which is connected upstream of the brake pressure sensor 2, a hydraulic pressure source 4, a valve block 5, an electronic open-loop and closed-loop control unit 6 and wheel brakes 7, 8, 9 and 10 which are connected to the valve block 5 and are assigned to two vehicle axles. The brake pressure sensor 2 is embodied as a dual-circuit master brake cylinder or tandem master cylinder which is provided with a pressureless pressure medium reservoir vessel (not illustrated). FIG. 1 shows that while the pressure sensor or tandem master cylinder 2 with the booster module 3 form a first assembly which can be handled independently, a second functionally capable assembly which can be handled independently is formed by the pressure source 4, the valve block 5, which is preferably arranged spatially separate from the first assembly 2, 3. The valve block 5 accommodates pressure control valves 17, 18, 19, 20 which are assigned to the individual wheel brakes 7, 8, 9, 10 and the input ports of which are connected to the pressure spaces 23, 24 of the tandem master cylinder 2 by means of two hydraulic lines 21, 22. The pressure control valves 17-20, which are operated as 2/2-way valves which are open in the currentless state (OC) 2/2-way valves, operate in what is referred to as the multiplex mode, the functional principle of which is known to a person skilled in the art and therefore does not need to be explained in more detail. The abovementioned pressure source 4 is embodied as a cylinder-piston arrangement, the piston 41 of which is driven by an electric motor 42 and bounds, in the valve block 5, a hydraulic pressure space 43 which is connected to the booster module 3 via a line 25. In the example shown, an electrical energy accumulator, provided with the reference number 44, is assigned to the electric motor 42.

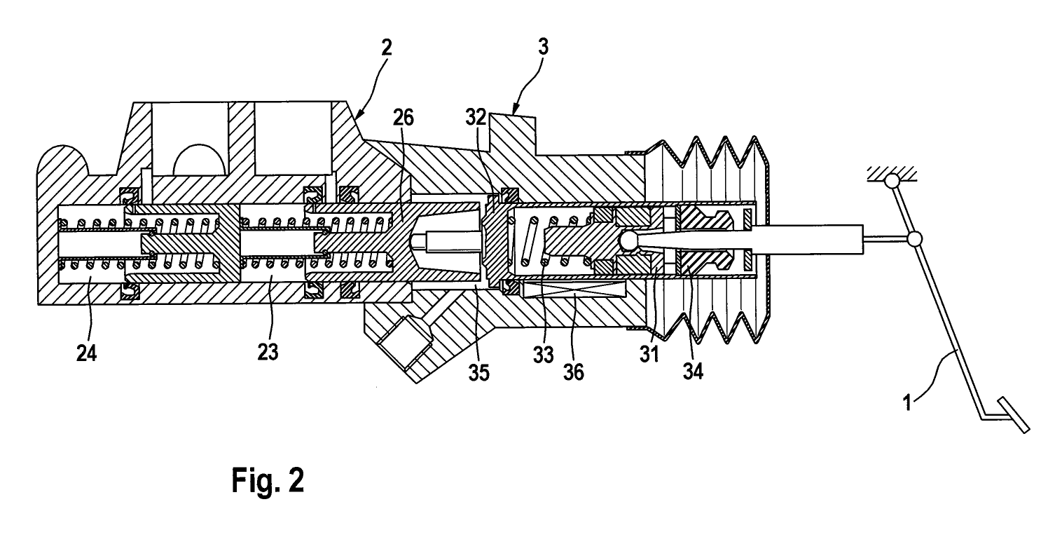

As is apparent in particular from FIG. 2, the booster module 3 has essentially a first piston 31, coupled to the brake pedal 1, and a second piston 32 in which the first piston 31 is displaceably guided with the intermediate connection of a compression spring 33. The compression spring 33 forms, together with an elastomer block 34, a pedal force simulator which generates, in accordance with the desired characteristic curve, an opposing force which can be felt at the brake pedal 1, and the function of which pedal force simulator is also known to a person skilled in the art. The second piston 32 and a first master cylinder piston 26 bound, in the housing of the booster module 3, a hydraulic space 35 to which, as already mentioned, the pressure source 4 is connected. The space 35 forms means for decoupling the brake pedal 1 from the tandem master cylinder 2. A travel sensor 36 which operates in a contactless fashion and which senses the relative travel of the first piston 31 with respect to the second piston 32 serves to sense the driver's deceleration request.

The method of functioning of brake systems of the brake-by-wire type is known essentially to a person skilled in the art. When a buildup of pressure occurs in the brake-by-wire operating mode, the brake pedal 1 is activated by the driver, with the driver deceleration request being sensed by the travel sensor 36. At the same time, the electric motor 42 is actuated with the effect of increasing pressure in the pressure space 43, the pressure of which pressure space 43 both holds the second piston 32 against a stop and causes the master cylinder pistons 26 to be shifted, to the left in the drawing. It is to be noted that suitable configuration of the diameters of the piston 41 and of the first master cylinder piston 26 permit the boosting ratio to be set over a large range. In the event of failure of the pressure source 4, force is transmitted from the brake pedal 1 to the first master cylinder piston 26 via the second piston 32 in a purely mechanical fashion.

1.-9. (canceled)

10. An electrohydraulic brake system for motor vehicles of a brake-by-wire type, having:
a hydraulic brake pressure sensor which can be activated by a brake pedal,
a master brake cylinder having at least one pressure space which is bounded by a master cylinder piston and to which wheel brakes of the motor vehicle can be connected,
means for decoupling the brake pedal from the brake pressure sensor,
a booster device which is connected upstream of the brake pressure sensor is configured to generate an activation force which acts on the pressure sensor,
means for sensing a vehicle deceleration request, the control signals of which can be fed to an electronic open-loop and closed-loop control unit,
a pedal force simulator which interacts with the brake pressure sensor and by which a restoring force which acts on the brake pedal can be simulated in a brake-by-wire operating mode, and
pressure control valves which can be actuated by the electronic open-loop and closed-loop control unit and are assigned to the wheel brakes,
wherein the booster device for boosting the activation force which is transmitted to the pressure sensor by the brake pedal is composed of a hydraulic pressure source and a booster module that is connected upstream of the pressure sensor,
wherein the pressure sensor forms, with the booster module, a first functionally capable assembly which can be handled independently, and
wherein the pressure source, the electronic open-loop and closed-loop control unit and a valve block, which accommodates the pressure control valves, together form a second functionally capable assembly which can be handled independently and which is arranged spatially separate from the first functionally capable assembly.

11. The electrohydraulic brake system as claimed in claim 10, wherein the hydraulic pressure source is embodied as a cylinder-piston arrangement, the pistons of which can be driven by an electric motor.

12. The electrohydraulic brake system as claimed in claim 11, wherein the second assembly has an electrical energy accumulator for feeding the electric motor.

13. The electrohydraulic brake system as claimed in claim 10, wherein the booster module has a first piston which can be coupled to the brake pedal, and a second piston in which the first piston is guided and the pedal force simulator is arranged, the second piston and the master cylinder piston bounding a hydraulic pressure space to which the hydraulic pressure source is connected and which forms the means for decoupling the brake pedal from the pressure sensor.

14. The electrohydraulic brake system as claimed in claim 13, wherein, in the event of a failure of the pressure source, the second piston can be connected to the master cylinder piston in a force-transmitting fashion.

15. The electrohydraulic brake system as claimed in claim 13, wherein the pedal force simulator has at least one elastic element which exerts a “spring force” portion of a simulator force which is dependent on the relative travel between the first piston and the second piston.

16. The electrohydraulic brake system as claimed in claim 13, wherein the pedal force simulator contains at least one of a steel spring, an elastomer body and/or friction connection components which exert the simulator force.

17. The electrohydraulic brake system as claimed in claim 16, wherein the pedal force simulator is formed by a steel spring and an elastomer body which is connected in series with the steel spring.

18. The electrohydraulic brake system as claimed in claim 13, wherein a sensor device for sensing a travel executed by the first piston is provided in the booster module.
